(19) United States
(12) Patent Application Publication
(10) Pub. No.: US 2015/0180992 A1
(43) Pub. Date: Jun. 25, 2015

(54) CONTENT DELIVERY ARCHITECTURE FOR CONTROLLING A DIGITAL PRESENCE

(71) Applicant: Limelight Networks, Inc., Tempe, AZ (US)

(72) Inventors: Jason Thibeault, Gilbert, AZ (US); Kirby Wadsworth, Wayland, MA (US); Edgardo Nazario, Lynnwood, MA (US); Peter Coppola, San Diego, CA (US); Jeff Freund, San Francisco, CA (US)

(73) Assignee: Limelight Networks, Inc., Tempe, AZ (US)

(21) Appl. No.: 14/134,037

(22) Filed: Dec. 19, 2013

(51) Int. Cl. H04L 29/08

(52) U.S. Cl. CPC H04L 67/24; H04L 67/02; H04L 67/20

(57) ABSTRACT

A method for managing and analyzing a digital presence throughout a content delivery network providing multiple channels for content delivery may include storing and distributing content in response to user requests using a plurality of edge servers. The method may also include managing a digital presence using a digital presence controller, the digital presence controller including a plurality of service modules that each manage and analyze at least one aspect of the digital presence. The plurality of service modules may manage the digital presence according to functional rule sets. The plurality of service modules may generate analytics descriptive of at least one aspect of the digital presence. The method may additionally include receiving inputs that control the digital presence by adjusting the functional rule sets and providing a quantitative assessment of the digital presence based on the analytics.

### CROSS-REFERENCE TO RELATED APPLICATIONS

This application is related to U.S. patent application Ser. No. ______ entitled “FEEDBACK LOOP FOR AUTOMATIC CONTENT ADJUSTMENT IN DIGITAL PRESENCE CONTROLS” (Attorney Docket No. 88673-876583 (172-NP)), filed concurrently herewith, which is incorporated herein by reference for all purposes.

### BACKGROUND OF THE INVENTION

A content delivery network (CDN) is a large distributed system of servers deployed in multiple data centers throughout the Internet. The goal of a CDN is to serve content to end-users with high availability and high performance. Besides better performance and availability, CDNs also offload the traffic served directly from the content provider's origin infrastructure. CDNs can include geographically distributed points of presence (POPs) to locate edge servers close to end users. CDNs are capable of delivering content in high demand with higher quality of service (QoS). Content can be requested from a CDN using a universal resource locator (URL). Various techniques are used to route a URL request to a nearby POP, for example, in order to efficiently retrieve content.

### BRIEF SUMMARY OF THE INVENTION

In one embodiment, a system for managing and analyzing a digital presence throughout a content delivery network providing multiple channels for content delivery may be presented. The system may include a plurality of edge servers that store and distribute content in response to user requests. The plurality of edge servers may be organized into one of a plurality of geographically distributed Points of Presence (POPs) in the content delivery network. The system may also include a digital presence controller that manages and analyzes a digital presence as provided by the content delivery network. The digital presence controller may include a plurality of service modules that each manage and analyze at least one aspect of the digital presence. The plurality of service modules may manage the digital presence according to functional rule sets. The plurality of service modules may generate analytics descriptive of at least one aspect of the digital presence. The system may additionally include a digital presence management interface that is communicatively coupled to the digital presence controller and configured to receive inputs that control the digital presence by adjusting the functional rule sets, and provide a quantitative assessment of the digital presence based on the analytics.

In another embodiment, a method for managing and analyzing a digital presence throughout a content delivery network providing multiple channels for content delivery may be presented. The method may include storing and distributing content in response to user requests using a plurality of edge servers. The plurality of edge servers may be organized into one of a plurality of geographically distributed POPs in the content delivery network. The method may also include managing and analyzing a digital presence as provided by the content delivery network using a digital presence controller, the digital presence controller including a plurality of service modules that each manage and analyze at least one aspect of the digital presence. The plurality of service modules may manage the digital presence according to functional rule sets, and the plurality of service modules may generate analytics descriptive of at least one aspect of the digital presence. The method may additionally include receiving, using a digital presence management interface that is communicatively coupled to the digital presence controller, inputs that control the digital presence by adjusting the functional rule sets. The method may further include providing, using the digital presence management interface, a quantitative assessment of the digital presence based on the analytics.

### BRIEF DESCRIPTION OF THE DRAWINGS

The subject matter that is regarded as the invention is particularly pointed out and distinctly claimed in the claims at the conclusion of the specification. The foregoing and other objects, features, and advantages will be apparent from the following detailed description taken in conjunction with the accompanying drawings.

FIG. 1 illustrates a block diagram of an embodiment of a content distribution system.

FIG. 2 illustrates a block diagram of an embodiment of a point of presence (POP) that is part of a content delivery network (CDN).

FIG. 3 illustrates a POP arrangement with a digital presence controller, according to some embodiments.

FIG. 4 illustrates an alternate POP arrangement with a digital presence controller, according to some embodiments.

FIG. 5 illustrates a configuration of a content delivery network using distributed presence controllers, according to some embodiments.

FIG. 6 illustrates a block diagram for a digital presence platform, according to some embodiments.

FIG. 7 illustrates a functional diagram of service module interactions, according to some embodiments.

FIG. 8 illustrates a digital presence platform interface for controlling a digital presence, according to some embodiments.

FIG. 9 illustrates a flowchart of a method for managing and analyzing a digital presence, according to some embodiments.

FIG. 10 illustrates an exemplary environment in which some embodiments may be implemented.

FIG. 11 illustrates one example of a computer system, according to some embodiments.

### DETAILED DESCRIPTION OF THE INVENTION

The ensuing description provides descriptions of exemplary embodiments only, and is not intended to limit the scope, applicability, or configuration of the disclosure. Rather, the ensuing description of the exemplary embodiments will provide those skilled in the art with an enabling description for implementing the embodiments of the claims. It will be understood that various changes may be made in the function and arrangement of elements without departing from the spirit and scope as set forth in the appended claims.

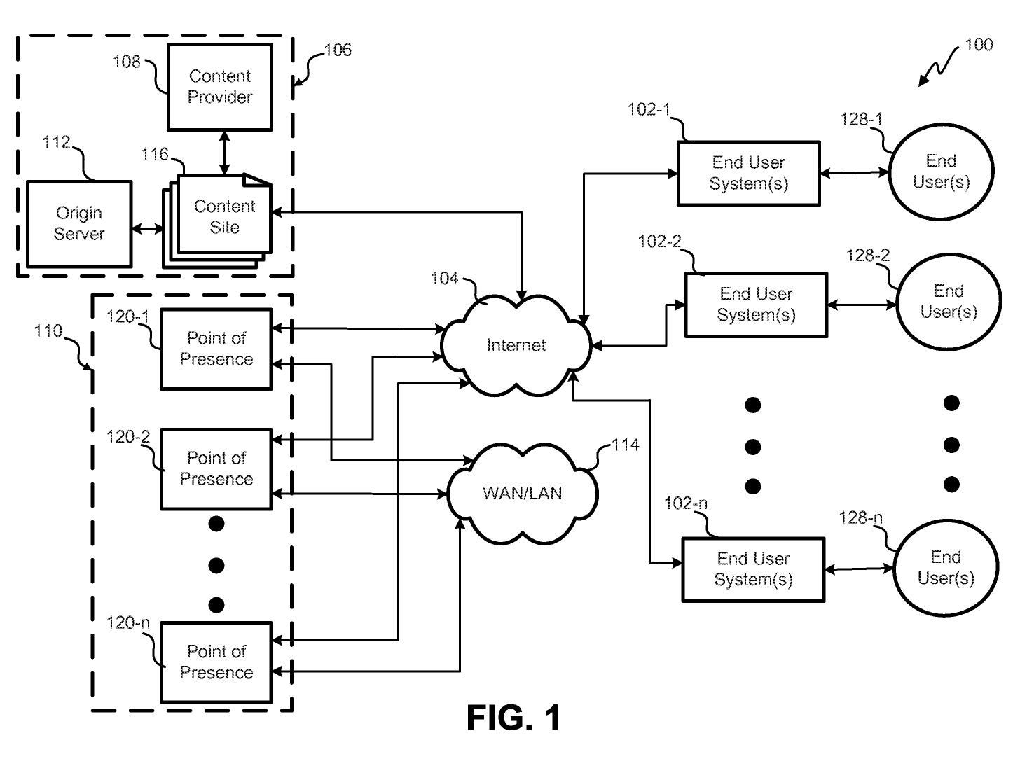

Referring first to FIG. 1, a block diagram of an embodiment of a content distribution system 100 is shown. The content originator 106 offloads delivery of the content objects to a content delivery network (CDN) 110 in this embodiment. The content originator 106 produces and/or distributes content objects and may include a content provider 108, a content site 116, and/or an origin server 112. The CDN 110 can both cache and/or host content in various embodiments for third parties, such as the content originator 106, to offload delivery and typically provide better quality of service (QoS) to a broad spectrum of end-user systems 102 distributed worldwide.

In this embodiment, the content distribution system 100 locates the content objects (or portions thereof) and distributes the content objects to one or more end-user systems 102. The content objects can be dynamically cached and/or hosted within the CDN 110. A content object may include any content file or content stream and could include, for example, video, pictures, data, audio, software, analytics, and/or text. The content object could be live, delayed, or stored. Throughout the specification, references may be made to a content object, content, content stream and/or content file, but it is to be understood that those terms could be used interchangeably wherever they may appear.

Many content providers 108 may use a CDN 110 or even multiple CDNs 110 to deliver the content objects over the Internet 104 to end users 128. The CDN 110 may include a number of points of presence (POPs) 120, which are geographically distributed through the content distribution system 100 to deliver content. Various embodiments may have any number of POPs 120 within the CDN 110 that are generally distributed in various locations around the Internet 104 so as to be proximate to end-user systems 102 in a network sense. Routing requests between the multiple POPs can be done during the DNS resolution and refined by assignment of an edge server. Other embodiments use routing, redirection, Anycast, DNS assignment and/or other techniques to locate the particular edge server that are able to provide content to the end users 128. In addition to the Internet 104, a wide area network (WAN), and/or a local area network (LAN) 114 or other backbone may couple the POPs 120 with each other and with other parts of the CDN 110.

When an end user 128 requests content, such as a web page, through its respective end-user system 102 while browsing, the request for the web page can be passed either directly or indirectly via the Internet 104 to the content originator 106. The content originator 106 may be defined as the source or re-distributor of content objects. The content site 116 may include an Internet web site accessible by the end-user system 102. For example, the content site 116 could be a web site where the content is viewable using a web browser. In other embodiments, the content site 116 could be accessible with application software or customized hardware other than a web browser, for example, a set top box, a content player, video streaming appliance, a podcast player, an app running on a smart phone, etc. The content provider 108 can redirect such content requests to the CDN 110 after they are made, or alternatively can formulate the delivery path by embedding the delivery path into the universal resource indicators (URIs) for a web page. In either case, the request for content can be handed over to the CDN 110 in this embodiment by having the end-user system 102 perform a DNS look-up so as to choose which of the multiple POPs 120 should provide the requested content.

A particular edge server may retrieve the portion of the content object from the content provider 108. Alternatively, the content provider 108 may directly provide the content object to the CDN 110 and its associated POPs 120 through prepopulation, i.e., in advance of the first request. The servers of the CDN 110 may include edge servers in each POP 120 that are configured to serve end user requests and/or store the actual content. The origin server 112 may continue to store a copy of each content object for the content originator 106. Periodically, the content of the origin server 112 may be reconciled with the CDN 110 through a cache, hosting, and/or pre-population algorithms. Some content providers could use an origin server within the CDN 110 to host the content and thus avoid the need to maintain a separate copy.

Once the content object is retrieved from the origin server 112, the content object may be stored within the particular POP 120 and may be served from that POP 120 to the end-user system 102. The end-user system 102 may receive the content object and processes it for use by the end user 128. The end-user system 102 could be a personal computer, media player, tablet computer, handheld computer, Internet appliance, phone, IPTV set top, video stream player, streaming radio, PDA, smart phone, digital music player, or any other device that can be configured to receive and process content objects. In some embodiments, a number of the end-user systems 102 could be networked together. Although this embodiment only shows a single content originator 106 and a single CDN 110, it will be understood that there could be many of each in various embodiments. Additionally, in some embodiments a content originator 106 could have a “captive” CDN 110 that is optionally used for its content when a third-party CDN is used to shed requests.

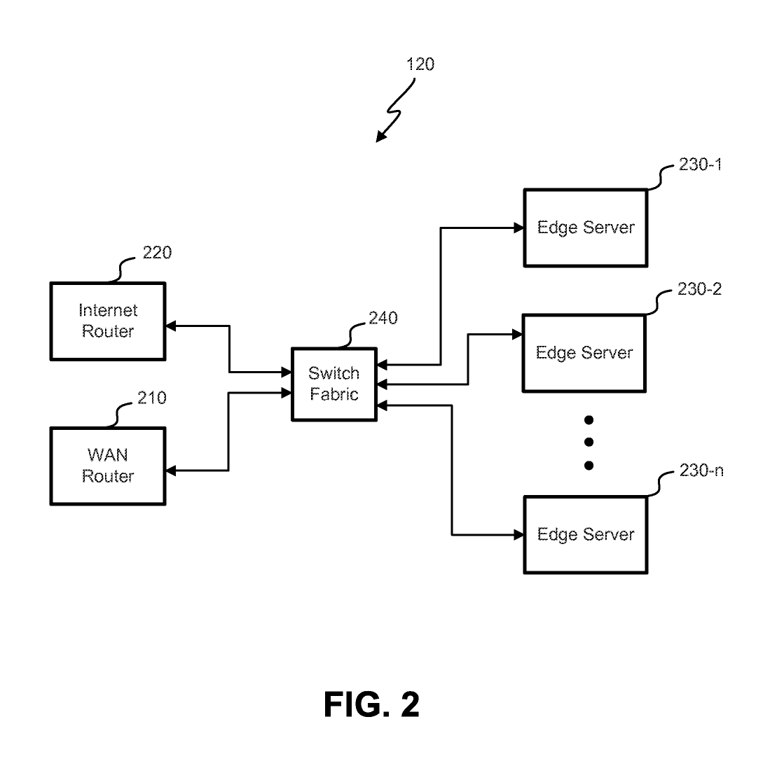

With reference to FIG. 2, a block diagram of an embodiment of a POP 120 is shown that is part of the CDN 110. Although only one POP 120 is depicted, there may be a number of POPs 120 similarly configured and geographically distributed throughout the CDN 110. The POPs 120 can communicate through a WAN router 210 and/or an Internet router 220 for locating content objects. An interface to the Internet 104 from the POP 120 accepts requests for content objects from end-user systems 102. The request comes from an Internet protocol (IP) address in the form of a URI.

Edge servers 230 may be implemented using general purpose computers loaded with software to perform various functions for the CDN 110. The edge servers 230 could be rack mounted or arranged in clusters. Multiple hardware processors and storage media could be used to implement each edge server 230. Each edge server 230 can load multiple instances of the same software and/or a variety of software to implement various functionalities. For example, software may be used on edge servers to implement switching fabric, routing, caching, hosting, DNS lookup, analytics, business rules, delivery assignment, and/or the like. The software instances can scale with the size of each POP 120. Different edge servers 230 may have a different set of functionality as defined by the software instances that are programmed to run on each edge server 230.

Switch fabric 240 assigns the request to one of the edge servers 230 according to a routing scheme such as round robin, load balancing, Cache Array Routing Protocol (CARP), random, and/or the like. In this embodiment, the switch fabric may be aware of which edge servers 230 have particular capabilities and may assign requests within the group having the particular capability to store and serve the particular content object referenced in a requested URI. A protocol such as CARP may be used in this embodiment to dispense the URIs between the edge servers 230. Every time that a particular URI is requested from the group, it may be assigned to the same edge server 230. For purposes of assigning a request, edge servers may be grouped together based on their ability to provide a requested content object, service a particular type of request, and/or the like.

In another embodiment, the switch fabric 240 assigns the request to one of the edge servers 230, which can either service the request or reassign it to a neighboring edge server 230 with software to perform an assignment master function. The switch fabric 240 sends each packet flow or request to an edge server 230 listed in the configuration of the switch fabric 240. The assignment can be performed by choosing the edge server 230 with the least amount of connections or the fastest response time. In some embodiments, the switch fabric 240 may assign the packet flow somewhat arbitrarily using round robin or random methodologies. When the chosen edge server 230 receives the packet flow, an algorithm may be used by the chosen edge server 230 to potentially reassign the packet flow between a group of edge servers to the one dictated by the algorithm. For example, the switch fabric 240 could choose a second edge server 230-2 being the next in the round robin rotation. The second edge server 230-2 could process the request and find that the first edge server 230-1 is being assigned this type of request. The request could then be reassigned to the first edge server 230-1 to fulfill.

As described above, the CDN 110 may be used to host content for others. Content providers 108 may upload content to an edge server 230 that hosts the content and functions as an origin server. After the content provider 108 places a content object in the CDN 110 it need not be hosted on the origin server 112 redundantly. Edge servers 230 can perform the hosting function within the CDN 110 with other edge servers 230 perhaps caching the same content that is hosted by another edge server 230.

Requests from end-user systems 102 are assigned to an edge server 230 that may cache the requested content object. On occasion, the edge server 230 receiving a request does not have the content object stored and available for immediate serving. This so-called “cache miss” triggers a process within the CDN 110 to effectively find the content object (or portion thereof) while providing adequate Quality of Service (QoS). The content may be found in neighboring edge servers 230 in the same POP 120, in another POP 120, or even an external origin server 112. The various edge servers 230 may be grouped for various URIs uniquely. In other words, one URI may look to one group of edge servers 230 on a cache miss while another URI will look to a different group of edge servers 230. In various embodiments, a particular URI could be assigned to one or more edge servers 230 in a single POP, multiple POPs or even in every POP. Generally, more popular content is stored on more edge servers 230 and more POPs 120.

When servicing requests from end-user systems 102, some form of content processing may be performed on the requested content before it is delivered from an edge server 230. In some cases, content processing may be performed by special software/hardware modules that are integrated with existing devices within the POP 120 or on the origin server itself 112. If the content processing is performed on an edge server 230 or on an origin server 112, the software/hardware performing the content processing may need to be distributed to each edge server 230 and/or each origin server 112.

Embodiments herein provide for an orchestrated and unified platform for managing and analyzing a digital presence. Businesses today struggle to deliver content effectively through the many digital channels that become available as computer and communication systems continue to evolve. Content delivery options may include traditional webpages, social media posts, Twitter updates, blogs, video presentations, podcasts, and/or the like. The difficulty presented by this expanded universe of digital communication is that content that provides meaningful customer interactions through some channels may not be successful on all channels. For example, posts that are effective on a social media site may be ineffective on a blog or podcast.

Many businesses currently struggle to understand the overall condition or state of health of what will be referred to herein as their digital presence as it is reflected by the delivery of and interaction with their content by users.

As used herein, the term “digital presence” may be used broadly to refer to how effectively digital content is delivered by a customer message to a group of users. A digital presence may incorporate a general user perception of a customer based on the web content available. A digital presence may also characterize both content popularity as well as the effectiveness with which is delivered, as both of these aspects may reflect upon how consumers feel about a customer's presence in the digital world around them. In some cases, a digital presence may be referred to as a digital footprint or a digital impression that exists in cyberspace and facilitates user interactions with a brand or certain products. Just as a physical presence can characterize how well products and services are delivered to a customer (e.g. how easy is it to get to a store location? how do customers respond to new products? how do customers respond to advertisements, promotions, and sales? how do store security measures affect customer perception of the brand?), a digital presence can characterize how well a customer's message is being conveyed to Internet users.

The embodiments described herein provide an effective means for managing and analyzing a digital presence that is delivered through multiple content channels, creating a single platform framework that includes multiple, integrated, inter-related systems that work together to deliver content. Using this platform, a customer can create content that is segmented for delivery through various channels that are monitored and controlled for effectiveness. This provides a simple and easy way to manage and deliver content to users in the most effective manner consistent with a desired digital presence.

In some embodiments, the digital presence platform can monitor a variety of factors related to the effectiveness of the content within the various delivery channels. For example, these factors could be related to the number of people requesting the content, the number of page views, user time spent on a webpage, number of comments or likes, and/or the like. Embodiments can quantitatively assess each factor to provide individual scores for each channel. Scores can generally be divided into two parts: how effective is the content, and how effectively the content is delivered. Scores for each facet of the digital presence platform can be aggregated and presented to the customer through a portal in order to provide both a top-level view of the customer's digital presence, as well as allowing the customer to dive into the details of each aspect that makes up their digital presence. Providing both real-time and historic feedback to a customer can allow them to adjust the way their content is delivered. Customers can also use the portal to adjust the types of content that are available through each channel. The data presented by the portal can be provided in real-time alongside historic feedback.

Initially, and/or after reviewing the analytics provided by the digital presence platform, customers can provide and/or adjust functional rule sets that dictate what content is available and how that content is delivered to users. These functional rule sets can control how content is transcoded, where it is geographically stored, bit rates that are provided, when content is posted, how content interacts with monetization modules for ad revenue, how content is kept secure, and/or the like. Further examples will be provided throughout this disclosure.

The digital presence platform may be an integrated part of a content network, such as the CDN described above. However, this invention need not be limited to traditional CDN environments. The digital presence platform may be implemented on cloud computing networks, local private networks, distributed CDNs, Federated CDNs, server farms, proprietary networks, and/or the like. Generally, the content network will be operated by an entity that is different from customers of the content network. As used herein, the term “customer” will generally refer to an entity that provides their content (e.g. webpages, videos, white papers, etc.) to the content network to provide to users. As used herein, the term “users” will generally refer to user devices that are used to access the customers content as provided by the content network.

In one exemplary embodiment, the digital presence platform may be provided as part of a CDN that accepts content from customers and delivers that content to users. This exemplary embodiment will be used throughout this disclosure to describe the function and operation of the digital presence platform. However, the principles and embodiments described herein could also be equally applied to other types of networks without imitation.

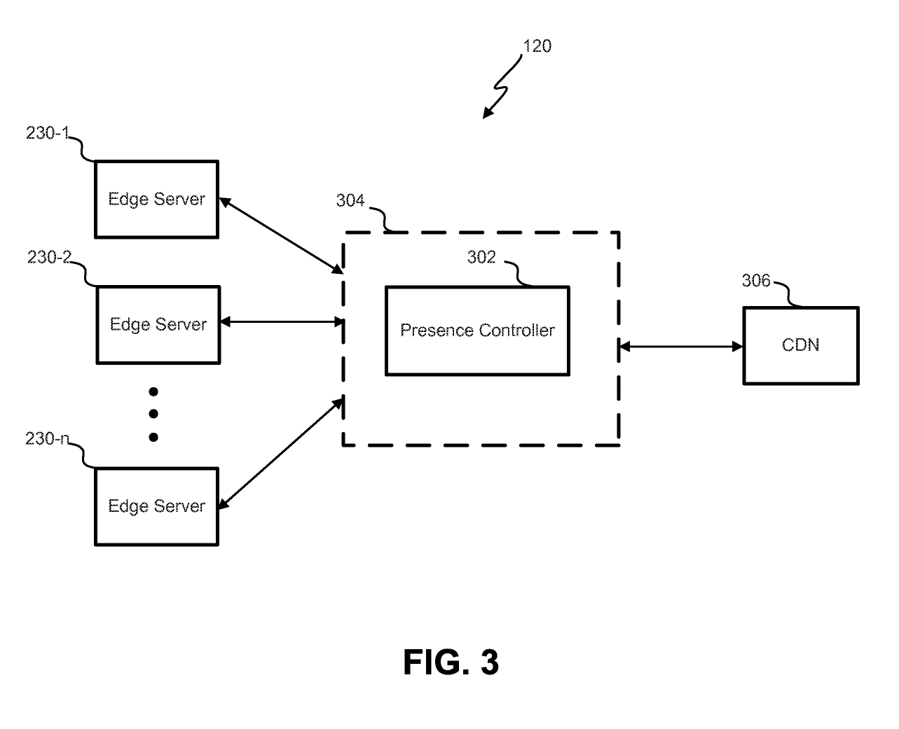

FIG. 3 illustrates a POP arrangement with a digital presence controller, according to some embodiments. The digital presence platform may be implemented using one or more presence controllers 302. The POP 120 may include various edge servers 230 along with a communication interface to communicate with the rest of the CDN 306. Within the POP 120, the presence controller 302 may be implemented on a server 304. The server 304 may be configured as a type of command center for the POP 120 such that functional rules provided to the presence controller 302 can control what content is stored on the edge servers 230, as well as how that content is delivered to users. The presence controller 302 may receive these functional rules through the interface to the CDN 306 and then dynamically adjust the contents of the edge servers 230. In some embodiments, content requests from users may be routed through the server 304 to the rest of the edge servers 230 such that the presence controller 302 can optimize how requests are handled according to the functional rule sets. In these embodiments, the presence controller 302 may be provided as a stand-alone server that performs the functions of the digital presence platform.

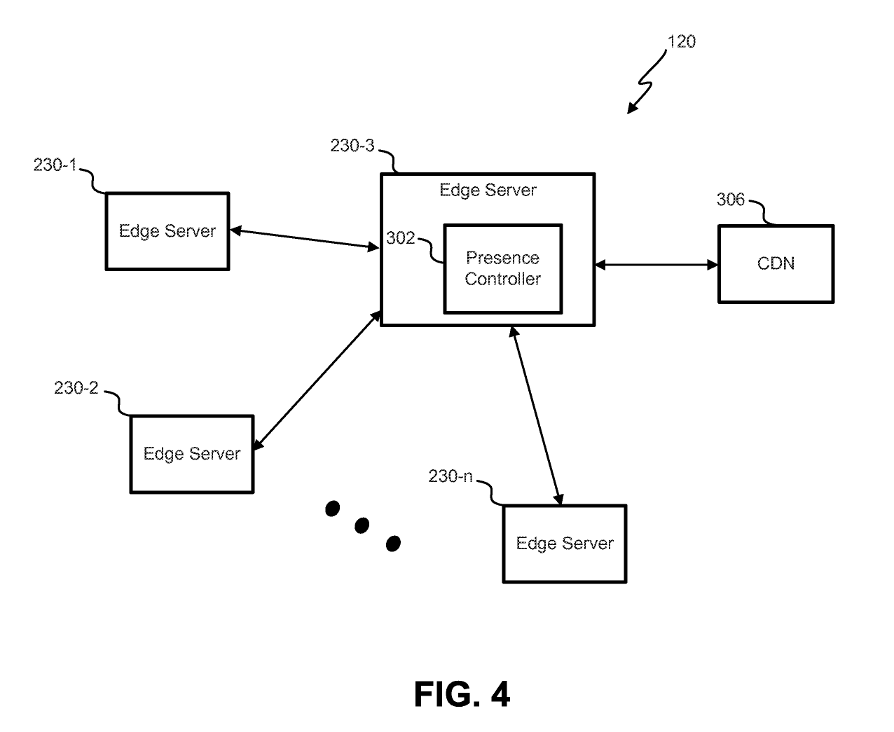

FIG. 4 illustrates an alternate POP arrangement with a digital presence controller, according to some embodiments. In this type of implementation, the presence controller 302 may be implemented on one of the edge servers 230-3. Although only one presence controller 302 is shown in this POP 120, multiple instances of the presence controller 302 may be distributed throughout the POP 120 on various edge servers 230. In this embodiment, the presence controller 302 may be implemented as a software module that operates on the edge server 230-3 along with other software modules that the edge server 230-3 traditionally uses to respond to user requests and deliver content.

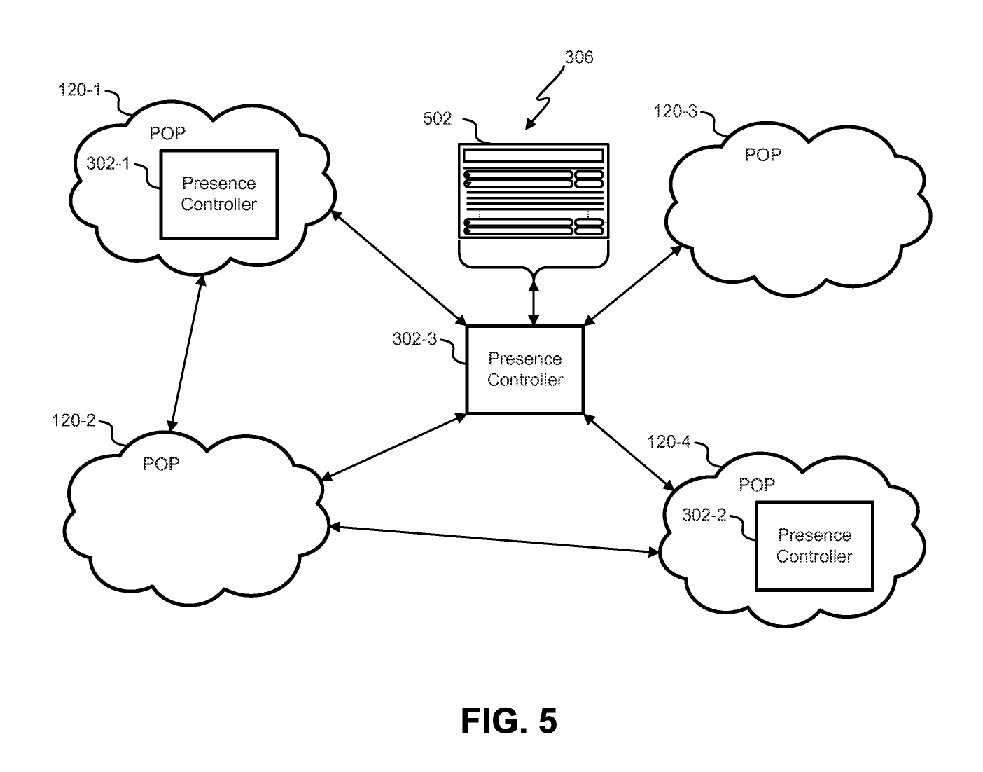

FIG. 5 illustrates a configuration of a content delivery network using distributed presence controllers, according to some embodiments. The CDN 306 may comprise multiple POPs 120 that may expand and/or contract over time. Generally, as demands on the CDN 306 increase, additional POPs may need to be added or additional edge servers may need to be added to the existing POPs 120. In order to facilitate this type of the dynamic expansion, the digital presence platform may be implemented using a plurality of presence controllers 302 that are distributed throughout the CDN.

In this particular embodiment, some POPs 120-1, 120-4 may include local instances of the presence controller 302, while other POPs 120-2, 120-3 need not include instances of the presence controller 302. Note that each instance of the presence controller 302 may be distinct and may be configured to perform different functions based on the location of the particular POP. Additionally, a presence controller 302-3 may exist as part of a command center for the entire CDN 306, or alternatively, for a portion of the CDN 306. Presence controller 302-3 may serve as an interface between various presence controllers 302-1, 302-2 distributed throughout the CDN 306. Presence controller 302-3 may also provide a portal 502 that allows a customer to view the analytics collected by the presence controllers 302 to assess their digital presence and to provide functional rule sets to the presence controllers 302 that control how content is stored and/or delivered.

The embodiment of FIG. 5 is merely exemplary, and not meant to be limiting. In light of the examples given herein, it will be understood that many different network configurations that implement distributed or centralized presence controller arrangements can be used.

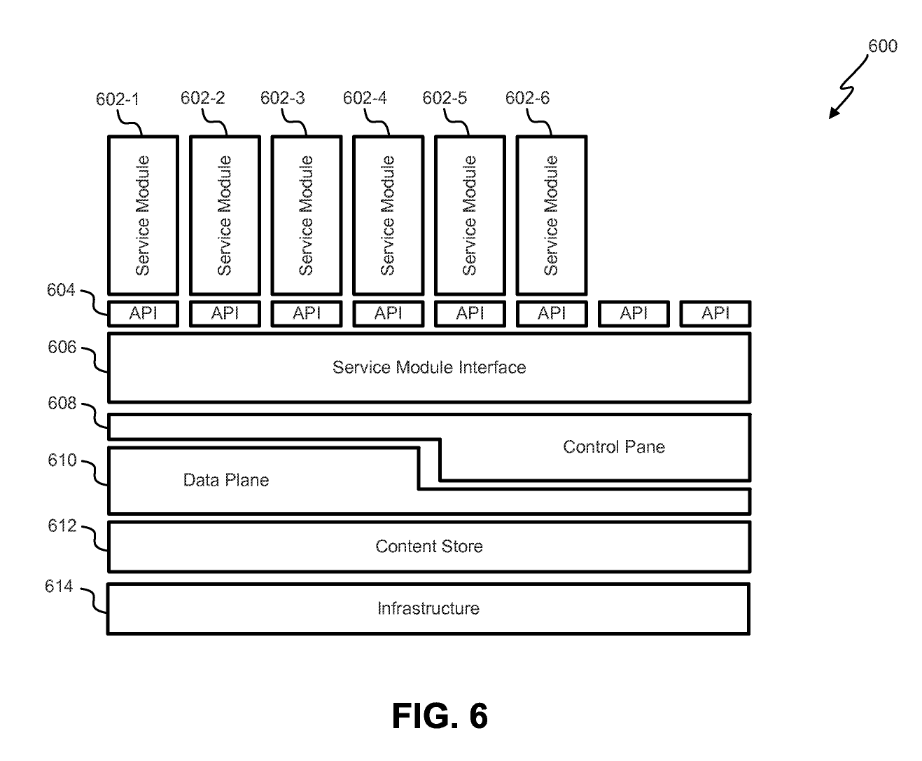

FIG. 6 illustrates a block diagram for a digital presence platform, according to some embodiments. Rather than cobbling together individual components and services, the digital presence platform provides a common framework for delivering content objects that make up a customer's digital presence. This may include web content, rich media, advertising, social media, third-party and other digital content material and interactions, and/or the like. By using a platform to create a holistic architecture for managing content, the effectiveness of a digital presence may be easily assessed. Additionally, the digital presence platform may be offered as a cloud-based service so that changes can be monitored in real time, and security threats can be detected in a more holistic manner than was possible with disconnected systems.

The digital presence platform may include an infrastructure layer 614 that may be primarily responsible for the ingress and egress of Internet traffic through the platform. In some embodiments, the infrastructure layer 614 may comprise the interconnected edge server network of a CDN.

The digital presence platform may also include a content store 612 that represents the collective repository of internally-generated and externally-consumed content that is made available to services within the platform through a data plane 610. In some embodiments, the content store 612 may include both a content repository and a data repository. The content repository can store any of the content that is being created or uploaded into the digital presence platform using the service modules 602 as will be described below. The content repository may represent a centralized repository for all content, and may be a combination of physical storage and/or other mechanisms to create logical connections between user accounts and content stored outside of the CDN. The data repository may represent a highly scalable, cross service data warehouse for any information associated with the delivery of or interaction with content delivered from the digital presence platform. For example, the data repository may store all data elements that are not considered content within the platform. These data elements can include log files, customer behavior records, performance data, and/or the like.

The data plane 610 can provide support for the transport of content. The data plane 610 can also ensure the content is routed, cached, transformed, and/or ultimately delivered to requesting users. In some embodiments, the data plane 612 may also be responsible for real-time consumption, categorization, and analysis of data collected from the various service module 602 connected to the digital presence platform 600. The data plane 610 can provide information to a control plane 608, and can accept operational directions from the control plane 608 via a policy engine executing functional rule sets.

The control plane 608 can observe traffic on the data plane 610, and can apply applications, functional rules, policies, and/or other intelligence to ensure that the right content is delivered in the right way to the right audience. The control plane can receive functional rules, application intelligence, and other information from the service module interface 606 and from individual service modules 602. In one sense, the control plane 608 may serve as the operational brains behind the digital presence platform 600, directing ingress and egress of content through the service module 602, the analysis and collection of analytical data, and the implementation of functional rules. The control plane 608 may be configured to monitor data traffic and state, collect analytical data, and enforce functional rules using a policy engine that can initiate predetermined actions based upon the results of data analysis carried out in the data plane 610.

The service module interface 606 can accept various service modules and can isolate the interfaces of the individual service modules such that they can be added to the digital presence platform 600 without affecting other parts of the platform. The service module interface 600 may include a standard API framework 604 to enable third parties to provide service modules not included with the original digital presence platform 600.

The service modules 602 represent the means by which the digital presence platform 600 can effectively manage and analyze a digital presence. As used herein, the term “service module” may broadly referred to an individual service that can form an integrated part of the digital presence platform 600. Service module 602 can be integrated into the platform 600 using the API framework 604 and can provide specific role-oriented functionality, such as managing webpages and websites. Individual service module 602 can communicate with each other through the platform 600 in order to share and utilize common framework elements. Each service module can be configured to use specific functional rules, data, interfaces, and tools. While many of the service modules may be provided as part of the platform 600, the service module interface 606 allows third parties to develop compatible service modules to expand functionality while maintaining a tightly integrated underlying platform.

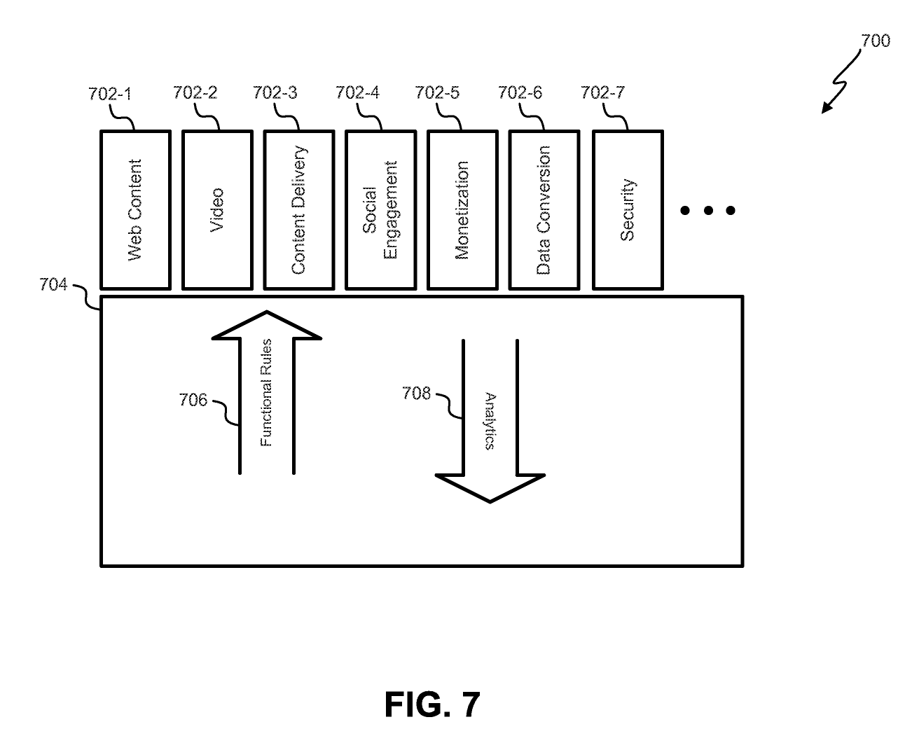

FIG. 7 illustrates a functional diagram 700 of the service module functions, according to some embodiments. This diagram includes to a digital presence controller 704 that includes a plurality of service modules 702. Generally, the digital presence controller 704 may provide sets of functional rules 706 to each of the service modules 702. Some functional rules 706 may be applied uniformly across all service modules 702, while other functional rules 706 may be applied only to specific service modules 702. As used herein, the term “functional rules” may broadly referred to policies, business rules, and/or other instructions that govern how the service modules 702 provide content to users.

In addition to providing functional rules 706 to the service module 702, the digital presence controller 704 may also receive analytics 708 from the service module 702. As used herein, the term “analytics” may broadly referred to any reporting information provided from the service modules 702 to the presence controller 704. Analytics 708 may include diagnostic information, statistical analyses of content usage, performance information, download times, user information, and/or the like.

The interaction between the service modules 702 and digital presence controller 704 in this particular implementation represents one way of managing and analyzing a digital presence. In order to more fully illustrate this interaction, the functional rules and analytics provided to/from some exemplary service modules will be described in detail below.

Some embodiments may include a web content service module 702-1. This module may also referred to as a content management module, and may provide a Web-based service to manage websites, regionalization of web content, and publication of content. The functional rules 706 provided to the web content service module 702-1 may describe how content is provided throughout the delivery network. For example, functional rules 706 could specify how content is cached throughout the CDN, where content is located geographically, times at which content should be made available, a refresh cycle or update cycle for content, and/or the like. In dynamic publication systems, the web content service module 702-1 can also dictate what content is published by selecting from among a plurality of available content objects based on the analytics. Note that these examples are merely exemplary, and not meant to be limiting. The web content service module 702-1 can be configured to control all aspects of how content is stored and published throughout a delivery network. Indeed, the web content service module 702-1 can perform a very important role in presenting a digital presence by controlling the content and the situations in which users interact with the content.

For each of the service modules 702, the analytics 708 may be provided in two broad categories: analytics describing the content itself, and analytics describing how the content was delivered. Analytics describing the content itself may be descriptive of how users react to a particular content object, such as a blog post, a video, a white paper, an online article, a picture, and/or the like. Generally, this set of analytics may describe how popular, useful, or intriguing a particular content object is to users. This type of analytic can generally be used to determine whether a content object is in demand, and may generally be a metric for determining the quality of a content object without necessarily considering the way in which the content object is delivered.

In contrast, the second type of analytics may disregard the quality of the content object itself while focusing more on how the content is delivered. In other words, this type of analytic may help the customer understand the user experience when interacting with their content objects. By way of example, these analytics may include indications of bit rate switching while watching video objects, buffering times, load times for webpages and images, a number of pages navigated through on a website before finding a specific content object, a number of times a content object was requested before being successfully delivered, whether it was necessary to change a format of the content object as it was delivered, and/or the like. In general, these analytics may include any information descriptive of how the content moves from the delivery network to the user, including speed, format, distance, latency, etc.

Each of the service modules 702 may infer different analytics from how users interacts with a content object. For example, a user could request a video. If that video is subject to a long load time or buffering interval, and the user quickly navigates away from the content object, it may be assumed that the user experience with the content object was negative in regards to how the content was delivered without necessarily reflecting on the quality of the content. On the other hand, if a content object is subject to a long load time or buffering interval, then this may be indicative of high quality content, in that the user was willing to wait through the loading/buffering in order to see the content object. In another example, a user may load a video, watch for 15 to 20 seconds, then navigate away from the content object. This could indicate a number of things. If the analytics indicate that the video was received quickly without significant delay, interruption, or poor quality of service, then the situation could indicate that the content itself is not popular or of high enough quality. On the other hand, if the analytics indicate that there were delays, interruptions, or poor quality of service, then the situation may indicate that the user experience in receiving the content was poor, without necessarily indicating that the content itself was unpopular or of poor quality.

For the web content service module 702-1, the analytics provided may be gleaned from the exemplary situations described above, along with many other types of user interactions. The analytics may include a number of successful views versus a number of unsuccessful views for each content object. They may provide statistical information describing how users reacted to poor quality of service, long load times, interruptions, bit rate changes, security requirements, advertisements, and/or the like. The analytics may describe geographic locations where the content objects were most popular, times where the content objects were most heavily requested, navigational tendencies of users requesting content objects, third-party websites where the content objects were most heavily requested, and/or the like. In short, the web content service module 702-1 can deliver analytics describing any aspect of the user interaction with particular content objects.

Some particular types of content object may require their own service module based on their uniqueness. For example, a video service module 702-2 may be provided to deal specifically with video objects. Functional rules 706 may be provided that control any and all aspects of the video delivery experience, such as managing, publishing, and syndicating digital video to websites and other endpoints, including mobile devices. By way of example, the functional rules 706 may govern formats in which videos became available, bit rates for the video, compression algorithms, volume levels, video characteristics (i.e. brightness, contrast, etc.), video player preferences, advertiser locations within videos, video life cycles, publishing removal times, related videos, related products or services, and/or the like.

The analytics 708 provided from the video service module 702-2 may be very similar to those of the web content service module 702-1, but specifically related to video objects. For example, the analytics 708 may include viewing times, number of advertisements watched, video locations where users lose interest or navigate away from the video, videos watched before or after watching a particular video, links that a user navigates through during video playback, user requests for changes in video format, bit rate, and/or compression, etc. Again, note that the analytics may be described broadly in the two categories described above, namely analytics that characterize the video itself, and analytics that characterize the delivery of the video, both of which make up the user experience in viewing the content and can play a key role in assessing a digital presence.

Some embodiments may also include a content delivery service module 702-3 configured to control the internal delivery mechanisms of a delivery network. When the digital presence platform is implemented within a CDN, the content delivery service module 702-3 may include functional rules 706 that determine how and where content object are stored within each POP, along with cache settings, partial object settings for distributing pieces of content objects throughout the CDN, policies for transferring content objects from one edge server to another edge server, delivery and handshake protocols for communicating internally within the CDN and with external user or devices, pre-warming cache policies for POP-to-POP transfers, and/or the like. The analytics may include stored statistics, compression statistics, cache efficiency statistics, transfer times, load statistics for each POP, and/or any other metric descriptive of how content is stored, transported, and delivered using the CDN. These analytics may be used to determine which POP location should cash each content object in order to provide the most seamless and efficient delivery to users. For example, the analytics may reveal that content object should be cashed in some locations, stored in other locations, and removed completely from some POPs.

Implementations that use other types of content delivery methods that are not necessarily linked to a CDN may use functional rules and analytics that are specific to the particular delivery infrastructure. The use of a CDN is merely exemplary. For example, a distributed CDN may utilize third-party cloud storage networks to store and deliver content. The functional rules 706 may then also include rules that limit storage and delivery costs incurred on both the CDN and/or the user. Some ISPs may use transparent caches that cash information locally before retrieving data from a CDN. Functional rules may describe how content is made available to transparent caches and may limit what ISPs are allowed to do with certain content objects. The analytics may describe how often content objects are delivered from transparent caches or from third-party cloud storage sites as compared to internal CDN POPs.

Some embodiments may include a social engagement service module 702-4 that is configured to manage how content is published to social networking sites and to analyze user responses characterizing its effectiveness. The social engagement service module 702-4 may be configured to automatically publish certain types of content to social media sites at predetermined times or in response to predetermined events. Functional rules 706 may dictate that content related to popular news items be published in response to such. For example, political commentary could be published more prominently to coincide with political election cycles. The functional rules 706 could also publish contents at certain times of day when people are more likely to take the time to watch a video on a social networking site. Publishing content late at night could allow the content to languish and move off of the front page of most social networking sites. The functional rules 706 may also dictate how content is linked to other promotional materials on social networking sites, and may even produce automated comments or “likes” in response to certain types of content. Comments may include links to content objects at other websites.

The analytics 708 generated by the social engagement service module 702-4 can be used to measure the effectiveness of the content postings. For example, some analytics may describe how popular content was with social network users. Other analytics may describe how many times posted content was shared, linked, or publicized by social network users. In some cases, direct user responses may be measured, such as comments or “likes.” For content that allows comments, a depth of conversation may be measured that includes number of comments, length of comments, average length of comments, number of different commentators, comments that mention other content objects, comments that provide links, and/or the like. The analytics could also describe when and where content postings are most effective. For example, the analytics could describe times of day when content postings were most viewed, geographic locations where interest was the strongest, length of videos that were the most effective, site locations or particular social networking sites that were most heavily trafficked, and/or the like.

Some embodiments may also include a monetization service module 702-5 that is configured to manage and analyze the financial characteristics of content objects. The fossil rules 706 may describe membership requirements or payment requirements in order to view certain types of content. They also may describe tiered pricing structures, free previews, credits, promotional material, cross promotions, when and where sales should occur, and/or the like. Generally, the monetization service module 702-5 may be configured to manage all the ways in which revenue can be generated from a particular content object or class of content objects. In some cases, this service module may also govern purchasing and payment processes. For example, the functional rules 706 could specify certain payment systems, such as PayPal®, credit card transactions, debit transactions, electronic check transactions, ACH transactions, and/or the like, that could be used to purchase access to certain content objects. Some functional rules 706 may govern a checkout process or customer cart to store object designations during shopping experience. For example, cookies or other type of state storage may be used to track content objects that are selected by a user.

The analytics 708 generated by the monetization service module 702-5 may generally describe how pricing and payment options affect the user's experience with the content objects. The analytics 708 may indicate how charging for content effects user demand, how certain purchasing processes or membership options affect user demand, which promotional items are most used, how bundling objects affects demand, how promotional pricing affects demand, and/or the like. The analytics 708 may also reveal time and geographic location advantages, i.e. where certain pricing models were effective, and what times most purchasing took place for certain delivery methods. The analytics 708 may also indicate which purchasing processes were most effective. For example, shopping cart methods could be compared to one-click purchasing methods. Delivery methods (instant download versus tangible media) could also be analyzed to determine their effect on content purchasing. In one embodiment, different purchasing processes may yield statistics for how often users begin a purchasing process without finishing, which may indicate how the purchasing process affects the demand on the underlying content for purchase.

Some embodiments may also include a data conversion service module 702-6 that is configured to govern how content objects are formatted and converted between different formats. The functional rules 706 may dictate how a CDN creates multiple format versions of a single content object. Each channel for delivery, such as mobile phones, set-top boxes, desktop computers, tablet notebooks, etc., may require its own media format. In the case of video, captions, screen size, and other considerations may also require different formats. Storing all of these formats at once within the CDN can require too much storage space. Therefore, the functional rules 706 may dictate which formats are used, and where they are cashed throughout the CDN. For example, a popular format may be available in each POP, while a less popular format may be available in only certain POPs in high-profile geographic locations.

Additionally, the data conversion service module 702-6 may include functional rules 706 that dictate where, when, and how data content objects are converted from one format to another. Instead of storing format objects in every possible format, some embodiments may only store content in the most popular formats and provide formatting conversion options to deliver content in alternate formats upon request. The functional rules 706 may dictate when these conversions can take place, such as just-in-time or after a certain number of requests, and may also dictate how long converted content objects persist in the CDN.

Analytics 708 provided by the data conversion service module 702-6 may include how often certain types of content objects were requested in particular formats, how often format conversion took place, geographic locations or times where format conversion is necessary, types of objects that are more likely to require format conversion, user devices or client websites that require conversion more often than others, and/or the like. The analytics 708 may also provide CDN statistics regarding processing power used for conversion, storage of multiple object formats, and effects on the performance of the CDN due to multiple-format objects.

Some embodiments may also include a security service module 702-7 this configured to apply and monitor security requirements on certain content. The functional rules 706 may dictate who is allowed to access certain content types. The functional rules 706 may also specify certain times, places, and/or situations in which content may be available to certain users. Security service module 702-7 may manage user accounts and user profiles that are used to gain access to gated content. Generally, this module may implement certain requirements that users must adhere to before content can be presented.

In some embodiments, the security service module 702-7 may also monitor attacks on the content delivery network. For example, this module may detect and mitigate denial of service attacks, phishing attacks, and other types of attacks meant to compromise network resources or user information. Content objects may be periodically scanned throughout the delivery network to search for known viruses or other malicious software that could infect the CDN or user devices. This module may also whitelist and/or blacklist certain users or networks that may harm the CDN.

In some embodiments, the security service module 702-7 may also implement data protection methods, such as secure data stores and encryption. This module may send encrypted content and may manage how that content is decrypted for playback or viewing on user devices. This module may also handle, store, and administer digital certificates and user authentications involving passwords or other unique tokens that are used to gain access to digital content.

The analytics 708 that are provided by the security service module 702-7 may generally describe how effective the CDN security regime is at detecting and mitigating malicious attacks. This module may also indicate monetary and performance costs associated with security measures and encryption. Statistics may also be generated as to how security measures affect user demand for content. For example, strict security regimes may effectively protect content at the expense of user access. Users may not deem the trouble of navigating through passwords and login screens worth accessing the content. Again, this may indicate that either the content is not in high demand, or that the security regime is too cumbersome. On the other hand, the fact that users have to manipulate cumbersome security regimes to access content may indicate that the content is of high quality. The analytics 708 may also provide statistics for a number of users that successfully or unsuccessfully attempt to provide security credentials, number of failed logins, and estimate a number of times the content would have been accessed but for the security measures in place.

It will be understood that the service module 702 depicted in FIG. 7 are merely exemplary and not meant to be limiting. Other service modules may also be included with the digital presence controller. For example, a mobile service module may be configured to interface with mobile data networks and to format, compress, and provide content to mobile devices such as smart phones. The mobile service module may be configured to access user accounts for mobile carriers and provide monetary information and data with information thereto. The mobile service module may also optimize mobile downloads to minimize bandwidth costs to users or to maximize revenue to the CDN or mobile data provider.

Additionally, other service modules may include a cloud storage service module that is configured to interact with third-party cloud storage systems to either augment the capacity of the CDN or to manage a federated CDN structured with third-party storage networks that are combined with the CDN infrastructure to augment the storage capacity and reach of the CDN. In other embodiments, an optimization service module may be provided that is configured to provide an analysis of analytics from other service modules. For example, scores may be provided for each type of analytic provided by each type of service module. As described below, scores may be assigned to individual functions, and overall scores may be assigned to categories so as to assess the effectiveness of a digital presence.

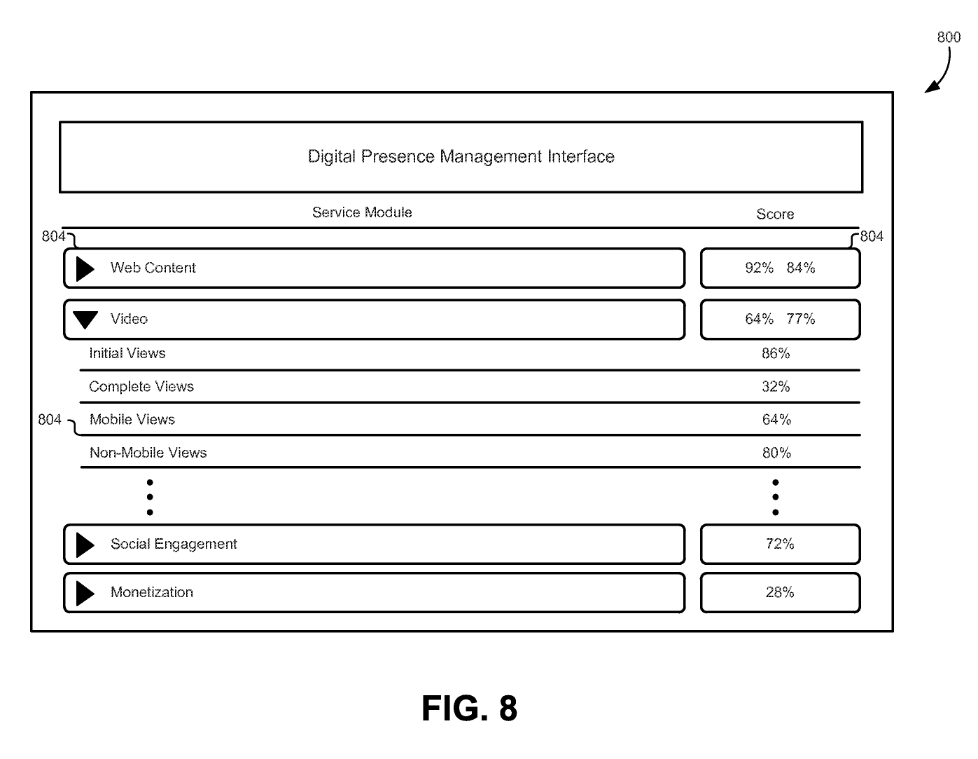

FIG. 8 illustrates a digital presence platform interface 800 for controlling a digital presence, according to some embodiments. One advantageous aspect of the one or more digital presence controller's that make up the digital presence platform is the ability for customers to interactively manage and analyze the effectiveness of their digital presence. Interface 800 represents one exemplary interface that may be used by customers. Interface 800 may be presented as part of a web-based or cloud-based portal provided by a digital presence controller in the CDN.

Interface 800 may provide visual controls for each service module available. In other embodiments, interface 800 may be organized by data type rather than by service module. For example, all data related to content viewed on a mobile device may be organized into a single category. In another embodiment, the interface may allow a customer to drill down into the details of each category 804. In this embodiment, the category 804 representing the video service module is open for inspection as could be represented to a customer. Analytic categories 804 provide various information to be reported to a customer that may be useful in assessing a digital presence. Although only a limited number of analytic categories 804 (initial views, complete views, mobile views, etc.) are shown, it will be understood that any of the analytics described throughout this disclosure may be displayed by the interface 800.

In some embodiments, the interface may also provide a quantitative score that represents the effectiveness of the digital presence in that area. For example, each analytic category 804 may have its own numerical score. This may be represented as a percentage, by a raw numeric score, by a letter grade, and/or the like. In some embodiments, the score may be based upon the recorded maximum value. For example, the score of 86% for the initial views may be relative to a maximum number of initial views recorded over a similar time interval. In other embodiments, the score may be relative to other customers of the CDN. For example the 86% could be relative to a maximum or average number of initial views for similar customers throughout the CDN or throughout the industry.

Generally, the score may represent the effectiveness of the digital presence in particular areas. A higher score may indicate that the customer's digital presence is expanding or is favorably viewed in a particular area. In contrast, a lower score may indicate that the customer's digital presence is unfavorably received or is gaining insufficient exposure and the particular area. In some embodiments, customers may provide their own scoring methodology. For example, a customer may desire to see the initial views where an advertisement was inserted at the beginning of a video. Generally, users may take the analytics provided by each of the service modules and combine them using logical or mathematical operators to generate new categories for reporting data. This allows each customer to customize what metrics are important and how they are shown in their own portal interface 800.

In addition to providing a numeric score for each analytic, scores for groups of analytics or for entire categories may be combined to provide an overall score in that area. In some embodiments, two scores may be provided. As discussed above, a first score may relate to the quality the content itself, while a second score may relate to how effectively the content was delivered to a user. For example, for the category of web content in interface 804, the first score of 92% may represent the quality of the content, while the second score of 84% may represent how effectively the content was delivered. Note the customers may see the score for each type of content. This may allow customers to quickly pinpoint problem areas where popular content has been delivered effectively, and were unpopular content is using unnecessary CDN resources.

Although not shown explicitly in interface 800, the customer portal may also provide a mechanism by which customers can provide, edit, alter, delete, and otherwise customize the functional rules that are provided to each service module. For example, by virtue of the analytics provided by the portal, a customer made determine that mobile content in a certain geographic area is being underserved. The customer could then change the functional rules for the content delivery service module and/or the data conversion service module such that the right type and format of content is served to the right device type and location. In another example, a customer may realize that certain social media posts are most effective at lunchtime when users are often browsing the Internet. The customer could adjust the functional rules for the web content service module and/or the social network service module to post the most popular content at the most effective times during high-traffic intervals on social network sites.

The power of the customer portal that provides interface 800 lies in its ability to provide analytical data to characterize a customer's digital presence, while giving the customer the necessary tools to adjust the way that their content is both presented and delivered in order to address deficiencies in the digital presence and to effectively utilize the available resources of the CDN. It will be understood that the types of analytics and the types of rules that can be provided by customers described herein are merely exemplary and not meant to be limiting. Different rules and different analytics can be combined, added, or removed depending on the particular needs of each individual customer. Because each customer is presented with their own account that stores their own customer profile, each interface 800 presented to a customer will reflect their own specific analytics and functional rules, as well as their own quantitative assessment of the effectiveness of their digital presence. The digital presence platform provides a tool for bringing all of the useful data regarding a digital presence together into a single portal to diagnose successes and failures of content presentation, as well as providing a means to adjust the content presentation to enhance the digital presence.

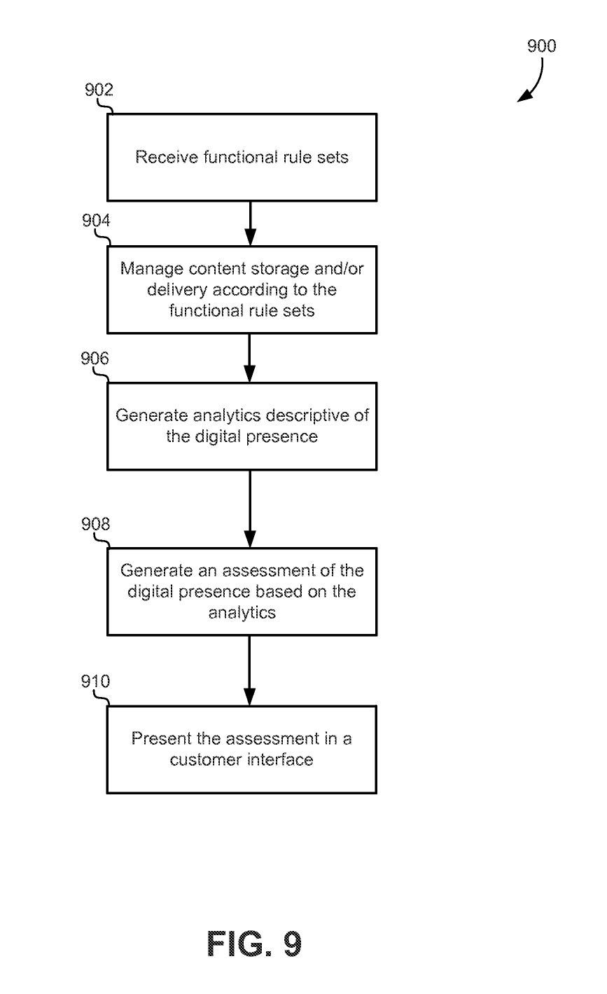

FIG. 9 illustrates a flowchart of a method for managing a digital presence, according to some embodiments. This method may include the preliminary steps of storing content in a CDN that provides multiple channels for content delivery. The CDN may include a plurality of edge servers that store and distribute content in response to user requests. The CDN may include a plurality of POPs that are geographically distributed, each including a plurality of edge servers. A digital presence controller may be implemented in one or more of the POPs, or in one or more central locations within the CDN to manage and analyze content distribution using a plurality of service modules as described above. The digital presence controller(s) may also provide a digital presence management interface through a customer portal that may be accessed by a customer. A custom API may also be provided such that third-party service modules can be provided by entities that are different than the operator of the CDN, but that are still compatible with the digital presence controller(s).

The method may include receiving functional rule sets (902). The functional rule sets may correspond to one or more of the service modules, and may be used by the service modules to manage the digital presence of the customer. In some cases, this may be accomplished by using the functional rule sets to control how content is stored in the CDN, and how content is delivered to users. The functional rule sets may include logical rules, event-based rules, as well as complex combinations of rules using conditional statements, logical operators, mathematical calculations, and/or the like. The functional rule sets may also access user profile data, as well as any of the analytics generated by the service modules or the digital presence controller.

The method may also include managing content storage and/or delivery according to the functional rule sets (904). The functional rule sets may be used to deliver instructions to the service modules such that CDN content is delivered and stored in accordance therewith as described above.

The method may additionally include generating analytics descriptive of the digital presence (906). Each analytic may be descriptive of at least one aspect of the digital presence. In some embodiments, each analytic may quantitatively describe particular aspects of content storage, content delivery, user experience, user feedback, latency, and/or the like. Analytics may also be inferred from raw numeric data. For example, content requests may be coupled with user actions that follow requests in order to score the effectiveness of content delivery methods or to score the quality of the requested content. In this way, it may be said that the analytics are related to a user perception of the digital presence. The analytics may be generated by one or more of the service modules.

The method may further include generating an assessment of the digital presence based on the analytics (908). The scores generated for each category of analytic may be combined together to provide a general score that characterizes an overall digital presence. In some cases, the quantitative assessment of the digital presence may include a score indicating how effectively content is being delivered to customers. In some cases, the quantitative assessment of the digital presence may also include a score indicating the quality of the content available to users. These two aspects may contribute to an overall digital presence score. It should be noted that in combining the individual analytics, customers may specify which analytics contribute to the overall digital presence score. For example, customers may emphasize certain analytics by weighting the more heavily, while simultaneously disregarding other analytics by weighting them less or removing them altogether from the calculation.

The method may also include presenting the assessment of the customer interface (910). The customer interface may also be referred to as a digital presence management interface, and may be communicatively coupled to the digital presence controller. In some embodiments, the customer interface may be presented as part of a customer portal by the digital presence controller. The customer interface may be configured to receive inputs that control the digital presence by adjusting the functional rule sets provided. Additionally, the customer interface may be configured to provide the quantitative assessment of the digital presence as described above.

It should be appreciated that the specific steps illustrated in FIG. 9 provide particular methods of managing and analyzing a digital presence according to various embodiments. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

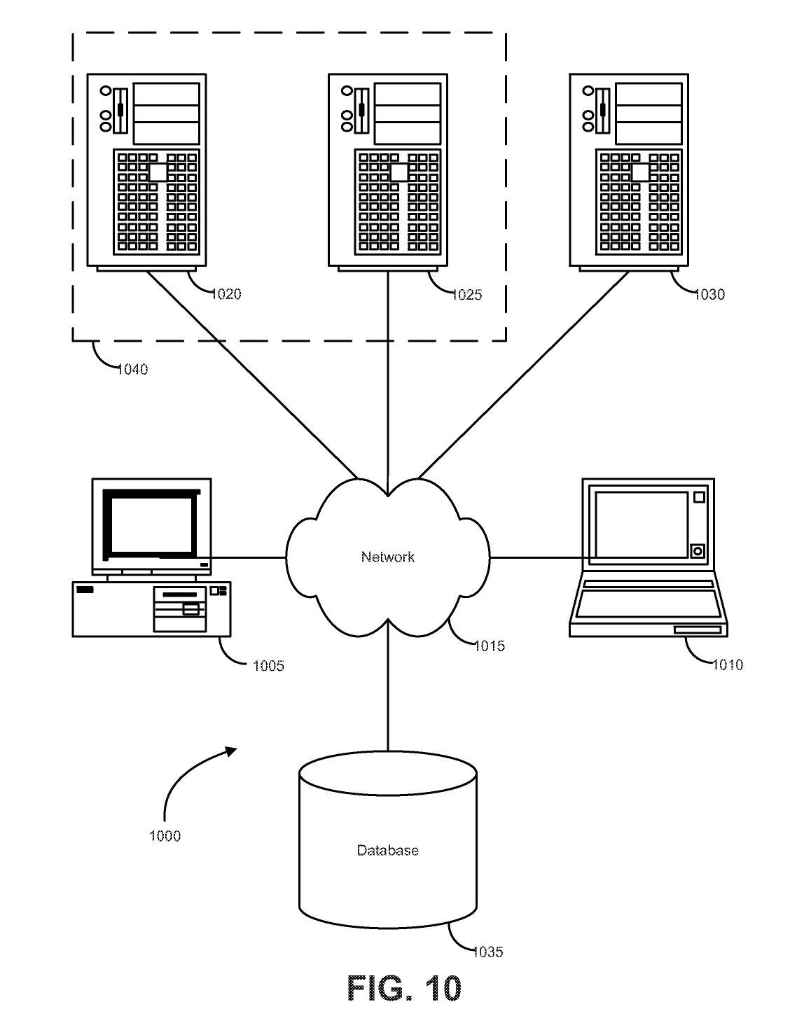

The digital presence controller, the edge servers, and the CDN network may be implemented on computer hardware components. For example, each of the embodiments disclosed herein may be implemented in various parts of a networked general-purpose computer system. FIG. 10 is a block diagram illustrating components of an exemplary operating environment in which various embodiments of the present invention may be implemented. The system 1000 can include one or more user computers 1005, 1010, which may be used to operate a client, whether a dedicated application, web browser, etc. The user computers 1005, 1010 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 1005, 1010 may also have any of a variety of applications, including one or more development systems, database client and/or server applications, and web browser applications. Alternatively, the user computers 1005, 1010 may be any other electronic device, such as a thin-client computer, Internet-enabled mobile telephone, and/or personal digital assistant, capable of communicating via a network (e.g., the network 1015 described below) and/or displaying and navigating web pages or other types of electronic documents. Although the exemplary system 1000 is shown with two user computers, any number of user computers may be supported.

In some embodiments, the system 1000 may also include a network 1015. The network may can be any type of network familiar to those skilled in the art that can support data communications using any of a variety of commercially-available protocols, including without limitation TCP/IP, SNA, IPX, AppleTalk, and the like. Merely by way of example, the network 1015 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 1020, 1025, 1030 which can be general purpose computers and/or specialized server computers (including, merely by way of example, PC servers, UNIX servers, mid-range servers, mainframe computers rack-mounted servers, etc.). One or more of the servers (e.g., 1030) may be dedicated to running applications, such as a business application, a web server, application server, etc. Such servers may be used to process requests from user computers 1005, 1010. The applications can also include any number of applications for controlling access to resources of the servers 1020, 1025, 1030.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1005, 1010. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 1005, 1010.

In some embodiments, an application server may create web pages dynamically for displaying on an end-user (client) system. The web pages created by the web application server may be forwarded to a user computer 1005 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 1000 may also include one or more databases 1035. The database(s) 1035 may reside in a variety of locations. By way of example, a database 1035 may reside on a storage medium local to (and/or resident in) one or more of the computers 1005, 1010, 1015, 1025, 1030. Alternatively, it may be remote from any or all of the computers 1005, 1010, 1015, 1025, 1030, and/or in communication (e.g., via the network 1020) with one or more of these. In a particular set of embodiments, the database 1035 may reside in a storage-area network (“SAN”) familiar to those skilled in the art. Similarly, any necessary files for performing the functions attributed to the computers 1005, 1010, 1015, 1025, 1030 may be stored locally on the respective computer and/or remotely, as appropriate. In one set of embodiments, the database 1035 may be a relational database, such as Oracle 10 g, that is adapted to store, update, and retrieve data in response to SQL-formatted commands.

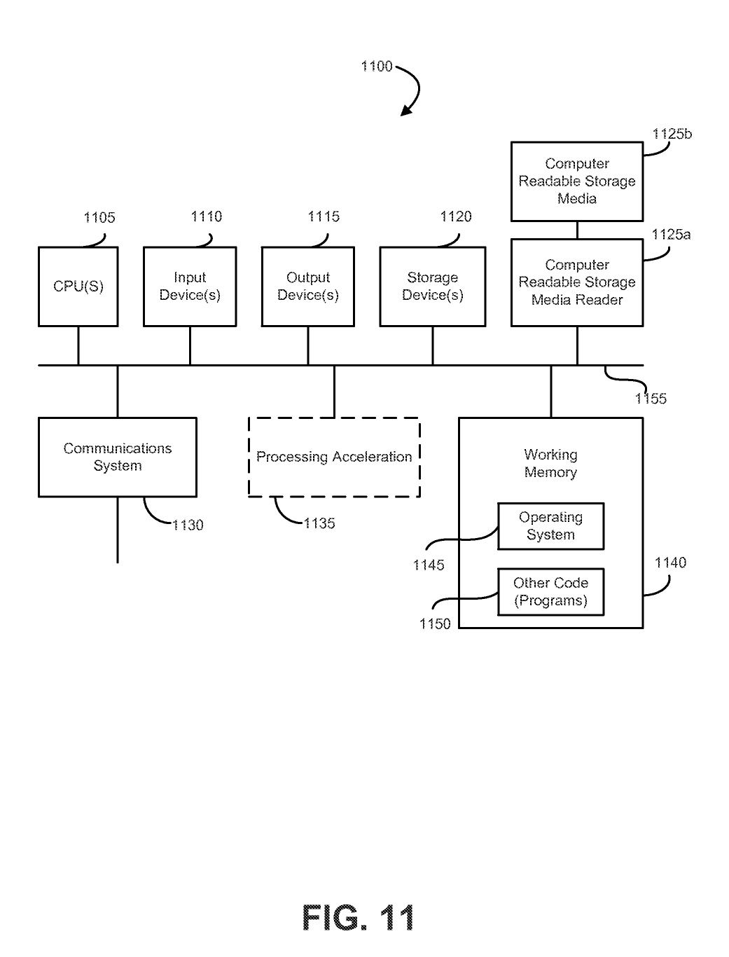

FIG. 11 illustrates an exemplary computer system 1100, in which various embodiments of the present invention may be implemented. The system 1100 may be used to implement any of the computer systems described above. The computer system 1100 is shown comprising hardware elements that may be electrically coupled via a bus 1155. The hardware elements may include one or more central processing units (CPUs) 1105, one or more input devices 1110 (e.g., a mouse, a keyboard, etc.), and one or more output devices 1115 (e.g., a display device, a printer, etc.). The computer system 1100 may also include one or more storage device 1120. By way of example, storage device(s) 1120 may be disk drives, optical storage devices, solid-state storage device such as a random access memory (“RAM”) and/or a read-only memory (“ROM”), which can be programmable, flash-updateable and/or the like.

The computer system 1100 may additionally include a computer-readable storage media reader 1125a, a communications system 1130 (e.g., a modem, a network card (wireless or wired), an infra-red communication device, etc.), and working memory 1140, which may include RAM and ROM devices as described above. In some embodiments, the computer system 1100 may also include a processing acceleration unit 1135, which can include a DSP, a special-purpose processor and/or the like.

The computer-readable storage media reader 1125a can further be connected to a computer-readable storage medium 1125b, together (and, optionally, in combination with storage device(s) 1120) comprehensively representing remote, local, fixed, and/or removable storage devices plus storage media for temporarily and/or more permanently containing computer-readable information. The communications system 1130 may permit data to be exchanged with the network 1120 and/or any other computer described above with respect to the system 1100.

The computer system 1100 may also comprise software elements, shown as being currently located within a working memory 1140, including an operating system 1145 and/or other code 1150, such as an application program (which may be a client application, web browser, mid-tier application, RDBMS, etc.). It should be appreciated that alternate embodiments of a computer system 1100 may have numerous variations from that described above. For example, customized hardware might also be used and/or particular elements might be implemented in hardware, software (including portable software, such as applets), or both. Further, connection to other computing devices such as network input/output devices may be employed. Software of computer system 1100 may include code 1150 for implementing embodiments of the present invention as described herein.

Each of the methods described herein may be implemented by a computer system, such as computer system 1100 in FIG. 11. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed by the computed without human intervention. Therefore, it will be understood in light of this disclosure, that each step and each method described herein may be altered to include an input and output to and from a user, or may be done automatically by a computer system. Furthermore, some embodiments of each of the methods described herein may be implemented as a set of instructions stored on a tangible, non-transitory storage medium to form a tangible software product.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A system for managing and analyzing a digital presence throughout a content delivery network providing multiple channels for content delivery, the system comprising:
a plurality of edge servers that store and distribute content in response to user requests, wherein:
the plurality of edge servers are organized into one of a plurality of geographically distributed Points of Presence (POPs) in the content delivery network;
a digital presence controller that manages and analyzes a digital presence as provided by the content delivery network, the digital presence controller comprising a plurality of service modules that each manage and analyze at least one aspect of the digital presence, wherein:
the plurality of service modules manage the digital presence according to functional rule sets; and
the plurality of service modules generate analytics descriptive of at least one aspect of the digital presence; and
a digital presence management interface that is communicatively coupled to the digital presence controller and configured to:
receive inputs that control the digital presence by adjusting the functional rule sets; and
provide a quantitative assessment of the digital presence based on the analytics.

2. The system for managing and analyzing the digital presence throughout the content delivery network providing multiple channels for content delivery of claim 1, wherein the analytics are related to a user perception of the digital presence.

3. The system for managing and analyzing the digital presence throughout the content delivery network providing multiple channels for content delivery of claim 1, wherein the functional rule sets are used by the content to delivery network to control how content is stored in the content delivery network, and how content is delivered to users.

4. The system for managing and analyzing the digital presence throughout the content delivery network providing multiple channels for content delivery of claim 1, further comprising a presence management server, wherein the presence manager operates at least in part on a presence management server.

5. The system for managing and analyzing the digital presence throughout the content delivery network providing multiple channels for content delivery of claim 1, wherein the presence manager operates at least in part on one or more of the plurality of edge servers.

6. The system for managing and analyzing the digital presence throughout the content delivery network providing multiple channels for content delivery of claim 1, further comprising an application programming interface that is communicatively coupled to a third-party service module for managing or analyzing the digital presence, wherein the third-party service module is provided by an entity that is different than an entity operating the content delivery network.

7. The system for managing and analyzing the digital presence throughout the content delivery network providing multiple channels for content delivery of claim 1, wherein the quantitative assessment of the digital presence comprises a component indicating how effectively content is being delivered to customers.

8. The system for managing and analyzing the digital presence throughout the content delivery network providing multiple channels for content delivery of claim 1, wherein the quantitative assessment of the digital presence comprises a component indicating the quality of the content available to users.

9. A method for managing and analyzing a digital presence throughout a content delivery network providing multiple channels for content delivery, the method comprising:
storing and distributing content in response to user requests using a plurality of edge servers, wherein:
the plurality of edge servers are organized into one of a plurality of geographically distributed Points of Presence (POPs) in the content delivery network;
managing and analyzing a digital presence as provided by the content delivery network using a digital presence controller, the digital presence controller comprising a plurality of service modules that each manage and analyze at least one aspect of the digital presence, wherein:
the plurality of service modules manage the digital presence according to functional rule sets; and
the plurality of service modules generate analytics descriptive of at least one aspect of the digital presence;
receiving, using a digital presence management interface that is communicatively coupled to the digital presence controller, inputs that control the digital presence by adjusting the functional rule sets; and
providing, using the digital presence management interface, a quantitative assessment of the digital presence based on the analytics.

10. The method for managing and analyzing the digital presence throughout the content delivery network providing multiple channels for content delivery of claim 9, wherein the analytics are related to a user perception of the digital presence.

11. The method for managing and analyzing the digital presence throughout the content delivery network providing multiple channels for content delivery of claim 9, wherein the functional rule sets are used by the content to delivery network to control how content is stored in the content delivery network, and how content is delivered to users.

12. The method for managing and analyzing the digital presence throughout the content delivery network providing multiple channels for content delivery of claim 9, further comprising a presence management server, wherein the presence manager operates at least in part on a presence management server.

13. The method for managing and analyzing the digital presence throughout the content delivery network providing multiple channels for content delivery of claim 9, wherein the presence manager operates at least in part on one or more of the plurality of edge servers.

14. The method for managing and analyzing the digital presence throughout the content delivery network providing multiple channels for content delivery of claim 9, further comprising coupling to a third-party service module for managing or analyzing the digital presence through an application programming interface, wherein the third-party service module is provided by an entity that is different than an entity operating the content delivery network.

15. The method for managing and analyzing the digital presence throughout the content delivery network providing multiple channels for content delivery of claim 9, wherein the quantitative assessment of the digital presence comprises a component indicating how effectively content is being delivered to customers.

16. The method for managing and analyzing the digital presence throughout the content delivery network providing multiple channels for content delivery of claim 9, wherein the quantitative assessment of the digital presence comprises a component indicating the quality of the content available to users.
